(19) United States
(12) Patent Application Publication
(10) Pub. No.: US 2008/0134886 A1
(43) Pub. Date: Jun. 12, 2008

(54) PRODUCTION OF MODERATE PURITY OXYGEN USING GAS SEPARATION MEMBRANES

(75) Inventor: John A. Jensvold, Benicia, CA (US)

Correspondence Address: WILLIAM H. EILBERG, THREE BALA PLAZA, SUITE 501 WEST, BALA CYNWYD, PA, 19004, US

(73) Assignee: GENERON IGS, INC., Houston, TX (US)

(21) Appl. No.: 11/608,919

(22) Filed: Dec. 11, 2006

(51) Int. Cl. B01D 65/00; B01D 69/02

(52) U.S. Cl. 95/54; 95/45; 96/10

(57) ABSTRACT

Oxygen, or other gas, of moderate purity is produced in a fiber membrane module. A diluent gas, such as air, is introduced into the module, on the shell side of the fibers, so as to mix with oxygen which has permeated through the fibers. The diluent gas not only reduces the concentration of oxygen in the product stream, to make oxygen of moderate purity, but also reduces the partial pressure of oxygen on the shell side of the fibers, thus enhancing the permeation of oxygen through the fibers. The invention can therefore enhance the productivity of the module, and/or reduce the energy required to operate the module.

### BACKGROUND OF THE INVENTION

The present invention relates to the field of non-cryogenic separation of gases into components, and provides an improved system and method especially suited for producing gas of moderate purity.

It has been known to use a polymeric membrane to separate air into components. Various polymers have the property that they allow different gases to flow through, or permeate, the membrane, at different rates. A polymer used in air separation, for example, will pass oxygen and nitrogen at different rates. The gas that preferentially flows through the membrane wall is called the “permeate” gas, and the gas that tends not to flow through the membrane is called the “non-permeate” or “retentate” gas. The selectivity of the membrane is a measure of the degree to which the membrane allows one component, but not the other, to pass through.

A membrane-based gas separation system has the inherent advantage that the system does not require the transportation, storage, and handling of cryogenic liquids. Also, a membrane system requires relatively little energy. The membrane itself has no moving parts; the only moving part in the overall membrane system is usually the compressor which provides the gas to be fed to the membrane.

A gas separation membrane unit is typically provided in the form of a module containing a large number of small, hollow fibers made of the selected polymeric membrane material. The module is generally cylindrical, and terminates in a pair of tubesheets which anchor the hollow fibers. The tubesheets are impervious to gas. The fibers are mounted so as to extend through the tubesheets, so that gas flowing through the interior of the fibers (known in the art as the bore side) can effectively bypass the tubesheets. But gas flowing in the region external to the fibers (known as the shell side) cannot pass through the tubesheets.

In operation, a compressed gas is introduced into a membrane module, the gas being directed to flow through the bore side of the fibers. One component of the gas permeates through the fiber walls, and emerges on the shell side of the fibers, while the other, non-permeate (retentate), component tends to flow straight through the bores of the fibers. The non-permeate component comprises a product stream that emerges from the bore sides of the fibers at the outlet end of the module. By controlling the flow of the non-permeate (retentate) component, one can control the concentration of the permeate component, because a change in pressure in the bores of the fibers will directly affect the permeation of gas through the fibers. A valve in the outlet conduit carrying the retentate component can be used to control the flow of retentate. Such control may be automated. That is, a computer can be connected to control the valve in response to a measured concentration of a component in the permeate stream.

Examples of fiber membrane modules are given in U.S. patent application Ser. No. 11/137,827, filed May 25, 2005, and U.S. patent application Ser. No. 11/383,301, filed May 15, 2006, the disclosures of both of which are hereby incorporated by reference. Another example is disclosed in U.S. provisional patent application Ser. No. 60/822,269, filed Aug. 14, 2006, the disclosure of which is also incorporated by reference.

The effectiveness of a membrane in gas separation depends not only on the inherent selectivity of the membrane, but also on its capability of handling a sufficiently large product flow. Gas permeates through the membrane due to the pressure differential between one side of the membrane and the other. Thus, to maintain the pressure differential, it has been known to remove the permeate gas from the vicinity of the fibers, after such gas has emerged on the shell side. Removal of the permeate gas maximizes the partial pressure difference across the membrane, with respect to the permeate gas, along the length of the module, thus improving both the productivity and recovery of the module. In the membrane module of the present invention, the permeate gas is made to flow in a countercurrent direction. That is, the permeate gas flows out of the module in a direction opposite to that of the basic feed stream.

The present invention is especially concerned with the case of producing oxygen having only moderate purity. While membrane systems are able to produce oxygen having a purity of 90% or greater, there are applications in which the required level of purity is much less. As used in this specification, the term “moderate purity oxygen” means oxygen in a concentration which is greater than 21% (the level of oxygen in ambient air) and up to about 40%. In the prior art, moderate purity oxygen has been produced by diluting a stream of oxygen with ordinary air, after the oxygen stream has left the membrane. The present invention provides a system and method in which such moderate purity oxygen is produced more efficiently than is possible with systems of the prior art.

### SUMMARY OF THE INVENTION

The present invention includes a system and method for producing oxygen, or other gas, of moderate purity. The system includes a membrane module, the module having a plurality of hollow fibers made of a polymeric material which non-cryogenically separates a gas, such as air, into components. The fibers define a bore side and a shell side; a gas component permeating the fiber will emerge on the shell side.

The improvement of the present invention resides in the use of a diluent gas, the diluent gas being injected into the module, on the shell side, so that the diluent gas mixes with the permeate gas before this mixture leaves the module. The diluent gas must contain a component which is the same as the permeate gas. In the preferred embodiment, the permeate or product gas is oxygen, and the diluent gas is air. The diluent gas effectively not only reduces the concentration of oxygen in the permeate, but also reduces the partial pressure of oxygen on the shell side. Thus, not only is the concentration of oxygen reduced, thereby producing oxygen of moderate purity, but the throughput of the system is enhanced, because the permeation of gas through the membrane is related to the partial pressure differential across the membrane.

The source of diluent gas may be a simple blower, and it is preferably connected to a valve for controlling the flow of diluent gas into the module.

The invention also includes the method of producing oxygen, or another gas, of moderate purity, using the system described above.

The present invention therefore has the primary object of providing a system and method for producing oxygen, or other gas, of moderate purity.

The invention has the further object of enhancing the efficiency of production of gas of moderate purity, using a non-cryogenic system.

The invention has the further object of enhancing the productivity of a gas separation module, and/or reducing the energy required for operating such module, in the production of gas of moderate purity.

The reader skilled in the art will recognize other objects and advantages of the present invention, from a reading of the following brief description of the drawings, the detailed description of the invention, and the appended claims.

### BRIEF DESCRIPTION OF THE DRAWINGS

FIG. 1 provides a block diagram of a prior art system for producing oxygen of moderate purity.

FIG. 2 provides a block diagram of the system for producing moderate purity oxygen according to the present invention.

### DETAILED DESCRIPTION OF THE INVENTION

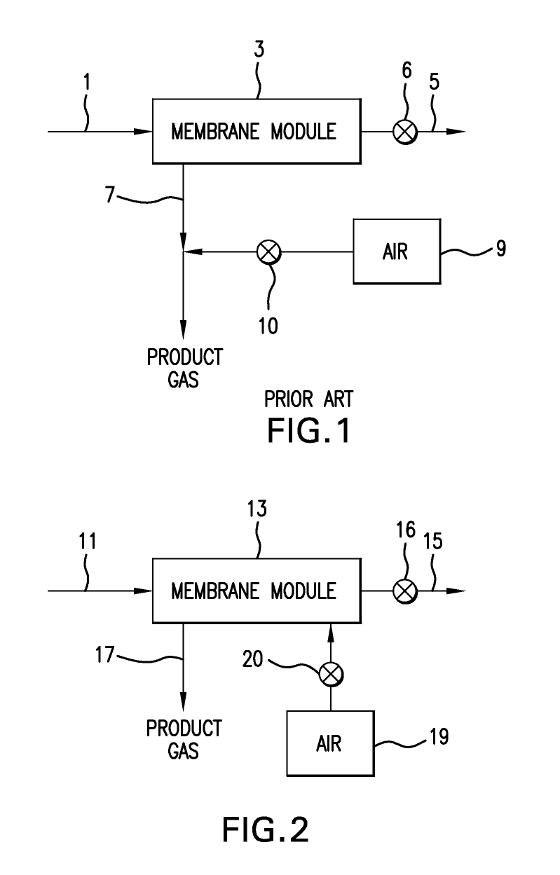

FIG. 1 provides a block diagram of a prior art system for making oxygen of moderate purity. It is assumed that the polymer used to make the membrane is such that it preferentially allows oxygen to permeate therethrough. Thus, in this case, oxygen is the permeate gas.

In the system of FIG. 1, feed gas comprising compressed air is conveyed through conduit 1 into membrane module 3. The membrane module separates the feed stream into an oxygen-enriched stream and an oxygen-depleted (nitrogen enriched) stream. The oxygen-enriched stream is the permeate gas, and the oxygen-depleted stream is the retentate. The oxygen-depleted stream exits the module through conduit 5, and the oxygen-enriched stream exits the module through conduit 7. Valve 6 controls the flow of the oxygen-depleted (retentate) gas, and therefore also indirectly controls the permeation of oxygen through the fiber membranes, by affecting the oxygen partial pressure on the high pressure side of the membrane.

Air is supplied to conduit 7, from source 9, so as to dilute the oxygen, reducing its purity to a desired level. Valve 10 controls the flow of this diluent air. Typically, oxygen of moderate purity means oxygen having a purity which is greater than 21%, and up to about 40%. A level of 21% corresponds to the concentration of oxygen in ordinary air.

A significant aspect of the prior art system of FIG. 1 is that the diluent air is combined with the oxygen outside of the membrane. That is, the oxygen is produced by the membrane, at a level of purity which is higher than that of the desired product, and this oxygen is then diluted with air. Since the dilution process is conducted entirely outside the membrane, it has no effect on the operation of the membrane module.

FIG. 2 illustrates the system of the present invention. Compressed air is introduced into module 13 through conduit 11. The compressed air is separated by the membranes into an oxygen-depleted (retentate) stream, which exits the module through conduit 15, and an oxygen-enriched stream which exits the module through conduit 17. Valve 16 controls the flow of the retentate stream, and thus indirectly controls the concentration of oxygen in the permeate stream. Valve 16 could be controlled by a computer (not shown) which can adjust the setting of the valve in response to a measurement of oxygen concentration in conduit 17.

The embodiment of FIG. 2 differs from that of FIG. 1 in that the diluent air, taken from source 19, is injected into the module. The flow of diluent air from the source is controlled by valve 20, and the diluent air is injected into the module on the shell side of the fibers. Also, as shown in FIG. 2, the air is injected at or near the outlet end of the module, so that the flow of diluent air will be countercurrent to the flow of feed gas into the module. In other words, using the orientation implied by FIG. 2, the feed gas flows from left to right, and the diluent air and permeate gas flow from right to left.

Introducing the air as shown in FIG. 2 dilutes the oxygen on the shell side of the fibers. This dilution reduces the partial pressure of oxygen, on the shell side. The reduction of partial pressure of oxygen enhances the rate of permeation of oxygen through the membranes, because this rate depends on the partial pressure difference between the bore side and the shell side.

The air introduced from source 19 is known as a “sweep” stream.

In normal operation of the membrane, it is expected that the oxygen concentration on the low-pressure shell side of the membrane will often be significantly greater than 21%, and greater than what can be deemed “moderate” purity. Thus, not only does the introduction of diluent air serve to reduce the concentration of oxygen, and thereby produce oxygen of moderate purity, but it also enhances the further permeation of oxygen from the bore side to the shell side of the fiber membranes, further improving the productivity of the module.

In short, the present invention produces oxygen of moderate purity more efficiently than could be done in the prior art. Not only does the membrane module work more efficiently, due to the enhanced partial pressure difference, but less power is required to operate the system. Such power is required to drive the compressor for the feed air, and the blower to provide the diluent air. The cost of providing the diluent stream is very small, because the diluent is provided at very low pressure, and a small blower is all that is needed.

The module of the present invention is preferably designed to provide countercurrent flow of the low pressure permeate and dilution streams, relative to the incoming high pressure feed air. The module must have a four-port construction, so as to accommodate 1) a high pressure air feed stream to the module, 2) a high pressure retentate stream exiting the module, 3) a low pressure diluent stream entering the low pressure (shell) side of the module, and 4) a low pressure product stream, comprising permeate plus diluent oxygen, exiting the module at the desired level of concentration. The flow and purity of the low pressure product stream is controlled by the inlet pressure and temperature, as well as the high pressure retentate stream flow and the flow rate of the diluent. For a hollow fiber module device, the four-port module could be designed for either bore-side or shell-side pressurization.

The following examples are based on computer simulations, and show the benefits expected from the use of the present invention.

### EXAMPLE 1

In this Example, it is assumed that the feed stream has a pressure of 130 psig, and a temperature of 40° C.

To evaluate different variations of the invention, it is helpful to establish the parameters of a reference case, in which there is no sweep stream. In the reference case, it is assumed that the module used is a Model 1-101000, sold by Generon IGS, Inc., of Houston, Tex. This module can produce 3350 scfh of oxygen having a concentration of 41.7%. If this product oxygen is diluted with ordinary air, outside the module, in the conventional manner, to a concentration of 30%, the production rate would be 7300 scfh of the 30% oxygen. The requirement for compressed air, comprising the feed stream, would be 8010 scfh, which is 1.11 times the flow rate of the 30% oxygen product stream.

Now assume that a sweep stream is provided, comprising ordinary air, according to the invention, and that there is no additional back pressure from the permeate. By selection of the sweep flow rate, and control of the flow of the retentate gas from the module, one can operate the module in several ways to increase either the productivity or the power efficiency of the separation process, or some combination of both, as compared with the reference case. In the following examples, it is assumed that the system includes one module, and that the dilution air, or sweep stream, flows in a countercurrent manner, on the shell side of the module.
a) A sweep stream of 46100 scfh results in an output stream of 7950 scfh of 30% oxygen, and has a compressed air requirement of 8135 scfh, which is 1.024 times the flow rate of the 30% oxygen product stream. This represents a 10% increase in productivity (7950 scfh versus 7300 scfh in the reference case) and a 7% decrease in power usage (1.11 versus 1.024), it being assumed that the power usage is linearly related to the compressed air requirement.
b) A sweep stream of 5650 scfh results in an output stream of 9080 scfh of 30% oxygen, and has a compressed air requirement of 9580 scfh, which is 1.055 times the flow rate of the 30% oxygen product stream. This represents a 25% increase in productivity (9080 scfh versus 7300 scfh in the reference case) and a 4.5% decrease in power usage (1.11 versus 1.055).
c) A sweep stream of 6400 scfh results in an output stream of 9885 scfh of 30% oxygen, and has a compressed air requirement of 10668 scfh, which is 1.079 times the flow rate of the 30% oxygen product stream. This represents a 36% increase in productivity (9885 scfh versus 7300 scfh in the reference case) and a 2% decrease in power usage (1.11 versus 1.079).
d) A sweep stream of 7350 scfh results in an output stream of 10900 scfh of 30% oxygen, and has a compressed air requirement of 12550 scfh, which is 1.15 times the flow rate of the 30% oxygen product stream. This represents a 50% increase in productivity (10900 scfh versus 7300 scfh in the reference case) and a 4% increase in power usage (1.11 versus 1.15).

### EXAMPLE 2

In this example, it is assumed that the feed stream has a pressure of 60 psig, and a temperature of 43° C.

In the reference case for this Example, it is assumed that the module used is the same module used in Example 1. At the temperature and pressure conditions assumed, this module can produce 1250 scfh of oxygen having a concentration of 39.7%. If this product oxygen is diluted with ordinary air, outside the module, in the conventional manner, to a concentration of 30%, the production rate would be 2600 scfh of the 30% oxygen. The requirement for compressed air, comprising the feed stream, would be 3250 scfh, which is 1.25 times the flow rate of the 30% oxygen product stream.

Now assume that a sweep stream is provided, comprising ordinary air, according to the invention, and that there is no additional back pressure from the permeate. As in Example 1, one can select a sweep flow rate, and one can control the flow of the retentate to obtain a desired permeate flow, and can thus operate the module in several ways to increase either the productivity or the power efficiency of the separation process, or some combination of both, relative to the reference case. In the following examples, it is again assumed that the system includes one module, and that the dilution air, or sweep stream, flows in a countercurrent manner, on the shell side of the module.
a) A sweep stream of 1630 scfh results in an output stream of 2910 scfh of 30% oxygen, and has a compressed air requirement of 3830 scfh, which is 1.135 times the flow rate of the 30% oxygen product stream. This represents a 12% increase in productivity (2910 scfh versus 2600 scfh in the reference case) and a 9.5% decrease in power usage (1.25 versus 1.135).
b) A sweep stream of 1980 scfh results in an output stream of 3275 scfh of 30% oxygen, and has a compressed air requirement of 3305 scfh, which is 1.169 times the flow rate of the 30% oxygen product stream. This represents a 26% increase in productivity (3275 scfh versus 2600 scfh in the reference case) and a 6.6% decrease in power usage (1.25 versus 1.169).
c) A sweep stream of 2175 scfh results in an output stream of 3480 scfh of 30% oxygen, and has a compressed air requirement of 4175 scfh, which is 1.20 times the flow rate of the 30% oxygen product stream. This represents a 34% increase in productivity (3480 scfh versus 2600 scfh in the reference case) and a 4% decrease in power usage (1.25 versus 1.20).
d) A sweep stream of 2410 scfh results in an output stream of 3750 scfh of 30% oxygen, and has a compressed air requirement of 4700 scfh, which is 1.26 times the flow rate of the 30% oxygen product stream. This represents a 43% increase in productivity (3750 scfh versus 2600 scfh in the reference case) and a 0.8% increase in power usage (1.25 versus 1.26).

The above examples suggest that, for operation at 130 psi, the best choice would be the first option, namely a sweep stream of 4600 scfh. For this option, the module requirement is reduced by 10% and the compressor cost and power requirements are reduced 7%. This would reduce the overall cost of the product stream by about 7%. For operation at 60 psi, the best option may be the third choice, namely a sweep stream of 2175 scfh. The module requirement is reduced by 34%, and the power required is reduced by 4%. This would reduce the cost of the product stream by roughly 10%. Both of the above scenarios provide significant savings over prior art methods. In general, the present invention can be operated to yield 10-50% more product flow than the prior art technology, while maintaining or even decreasing the cost of power required.

The above examples are both based on the assumption that the desired oxygen concentration in the product stream will be 30%. The present invention can be used for virtually any level of oxygen, but the process is optimal for use with existing membrane technology, when used to produce oxygen in a concentration of 21% to about 40%.

The above examples are concerned with the production of oxygen. The principle of the invention could also be applied to the production of other gases, and should not be deemed limited to oxygen. In the more general case, the diluent gas must include a component which is the same as the permeate gas. In the examples given above, where the diluent gas is air, such component is oxygen, which is the same as the permeate gas. But the same principle could be applied to other combinations of gases.

The invention can be modified in various ways, as will be apparent to the reader skilled in the art. The exact design of the membrane module can be varied, and the valving arrangements can be changed. The definition of moderate purity oxygen could also be expanded to include streams having somewhat more than 40% concentration. These and other modifications should be considered within the spirit and scope of the following claims.

What is claimed is:

1. In a gas separation system, the system including a module containing at least one gas separation membrane, the membrane defining a bore side and a shell side, the membrane being selected to separate an incoming feed gas stream into first and second components, the module including means for withdrawing a selected component as a product gas,
the improvement comprising a source of diluent gas, located external to the module, and means for conveying the diluent gas into the module so as to dilute the product gas while the product gas is still within the module.

2. The improvement of claim 1, wherein the diluent gas includes a component which is identical to said selected component.

3. The improvement of claim 2, wherein the product gas is oxygen, and wherein the diluent gas is air.

4. The improvement of claim 1, further comprising valve means for controlling a flow of the diluent gas from the source into the module.

5. A system for producing oxygen of moderate purity, comprising:
a) a membrane module, the module including at least one fiber membrane made of a material which non-cryogenically separates air into components, the fiber defining a bore side and a shell side,
b) means for conveying compressed air into the membrane module,
c) means for withdrawing a retentate stream from the bore side of the fiber,
d) means for withdrawing a permeate stream from the shell side of the fiber, the permeate stream including oxygen, and
e) a source of air, external to the module, and means for conveying air from said source into the module, wherein air from the source dilutes said permeate stream inside the module.

6. The system of claim 5, further comprising a valve connected to said source, the valve comprising means for controlling a flow of air into the module.

7. A method of making a product gas of moderate purity comprising:
a) directing a feed gas into a membrane module, the feed gas including at least two components, wherein a component of said feed gas comprises a product gas to be made, the membrane module including a fiber membrane capable of separating the feed gas into components including said product gas, the membrane defining a bore side and a shell side,
b) conveying a diluent gas into the module, such that the diluent gas mixes with said product gas on the shell side of the fiber membrane and inside the module, and
c) withdrawing said product gas, diluted by said diluent gas, from the module.

8. The method of claim 7, wherein the diluent gas is selected to include a gas which is identical to said product gas.

9. The method of claim 8, wherein the feed gas is selected to comprise air, wherein the product gas is selected to comprise oxygen, and wherein the diluent gas is selected to include oxygen.

10. The method of claim 9, wherein the diluent gas is selected to comprise air.

11. The method of claim 7, further comprising controlling a flow of said diluent gas into the module.
